(19) United States
(12) Patent Application Publication
(10) Pub. No.: US 2008/0298690 A1
(43) Pub. Date: Dec. 4, 2008

(54) Digital Photo Content Processing System and Method and Apparatus for Transmitting/Receiving Digital Photo Contents Thereof

(76) Inventors: Myoung-Hwan Oh, Daejeon (KR); Hee-Joong Ahn, Choongcheongnam-do (KR); Ji-Eun Kim, Daejeon (KR); Il-Yeon Cho, Daejeon (KR); Dong-Won Han, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/096,100

(22) PCT Filed: Nov. 28, 2006
(86) PCT No.: PCT/KR2006/005074

§ 371 Date: Jun. 4, 2008

(30) Foreign Application Priority Data
Dec. 7, 2005 (KR) 10-2005-0119102
May 9, 2006 (KR) 10-2006-0041669

(51) Int. Cl. G06F 17/00

(52) U.S. Cl. 382/224

(57) ABSTRACT

A system for processing digital photo contents in a digital camera is disclosed. The system includes a content transmitting unit, and a content receiving unit. The content transmitting unit creates an image by photographing objects in a photographing area, requests supplementary information to at least one of persons in the photographing area, receives personal IDs from at least one of target persons, composes digital photo contents using the created image and the personal ID and stores the composed digital photo contents, and transmits after classifying the stored digital photo content by the received personal ID. The content receiving unit transmits an own personal ID when a request for supplementary information to identify a target person from a content transmitting unit of a photographer, receives digital photo contents composed using an image captured from the content transmitting unit and the personal ID, and displays the received digital photo contents.

### TECHNICAL FIELD

The present invention relates to a system for processing digital photo contents in a digital camera; and more particularly, to a system for automatically classifying and transmitting digital photo contents, and a method and apparatus for transmitting/receiving a digital photo contents in the system.

### BACKGROUND ART

Digital cameras including a convergence device having a digital camera function are easy to carry and allow a user to instantly check a photographing result without development. Such advantageous features of the digital camera enable the user to save time and cost.

A photographer can photograph several tens and hundreds pictures in a short time using a digital camera, and such pictures generally include other person's images rather than the photographer himself. After capturing the images, the photographer must manually classify and manage the captured images according to the persons included in each of the pictures.

Picture information may include a file name, a file size, a file date, a camera manufacturer name, a camera model name, a photographing date, a resolution, an orientation, a flash state, a focus distance, a shutter speed, an iris value, a subject distance, an exposure level, and a spot mode. As described above, most information relates to photographing conditions. The photographer may use only the photographing data among the information for classifying and managing the captured images. Therefore, in order to classify the captured images by persons and places in each image, the photographer must manually classify the captured images although the captured images are automatically classified by the photographing data through a digital camera.

Also, the classified images may be appropriately compressed and transmitted to individuals based on desired methods. That is, some of the individuals prefer to receive the images through an e-mail or others want download the images from a file server after the image are uploaded to the file server.

As a conventional method for managing and classifying images, a method of adding predetermined user data into previously-composed digital images was introduced. However, the conventional method still requires a user to manually classify the digital images and add data to the digital image at least one time because a time of creating the image and a time of adding data are different each other.

In order to overcome such a problem, another conventional image managing method was introduced. In this conventional method, images are captured using a camera, persons in the captured image are analyzed, and the captured images are transmitted to the analyzed persons using registered data. The conventional method uses the image recognition technology to analyze the persons in the captured images. However, it is not easy to process image data for the image recognition in an appropriate time through digital cameras. Image recognition operations take comparatively long time to process even if a server-level computer having a high performance processor and sufficient computing resources are used. Also, the image recognition rate is not perfect. Therefore, it is impossible for a camera device, which has limited resources and a limited performance processor, to analyze persons in a captured image at the moment that the persons are photographed using the digital camera without using additional image processing device.

As another conventional image managing method, a method for storing a captured image with supplementary non-visual information of persons was introduced. In this method, wireless or infrared ray based electrical tags are attached at persons and objects, and those tags radiate supplementary non-visual information regularly. A camera includes a receiving module and receives the radiated supplementary non-visual information through the receiving module at the moment of capturing images, for example, when a shutter is activated. Then, image contents are composed using the supplementary non-visual information.

In the method for storing the captured image with the supplementary non-visual information, a photographer dose not have any information related to target persons to photograph and receives the supplementary non-visual information such as the names of the target persons, a telephone number, a tag ID, and a URL of a server for obtaining additional information or an e-mail address at the moment that the photographer activates a shutter. Herein, a transferring medium may be an infrared ray.

However, the method for storing the captured image with the supplementary non-visual information requires the target persons to radiate electric wave to the camera similar to using a TV remote controller in order to transfer the supplementary information of the target person to a photographer. That is, the target persons are required to stare the camera for a moment as like using a TV remote controller in order to transmit the supplementary non-visual information. The supplementary non-visual information is transmitted through a medium having directivity such as infrared rays. The photographer needs to check whether the supplementary information transmitted from the target persons is recognized within a photographing area or not through a view finder of a camera before capturing the image of the target person. Also, the method requires accessing a web server using additional computers in order to obtain additional information excepting the received supplementary non-visual information.

As described above, the target person always radiates non-visual information although a photographer dose not request to transmit the related information, and the camera simply receives the non-visual information transmitted from the target person. Since any photographer having a camera with a function of receiving the information from an object can receive the information from any objects, it may disturb a personal privacy.

Furthermore, a synchronization problem must be considered to instantly receive information transmitted from all tags attached at photographed objects in order to receive the non-visual information transmitted from the tags at a short time. Although a pre-determined time period is given to receive the supplementary non-visual information from the tags after activating the shutter, the transmitted supplementary non-visual information may be lost when an obstacle is located between the camera and the target object to photograph because the supplementary non-visual information is not short information such as a personal ID but it is comparatively long information. Therefore, it is ineffective to use a straight or a directional light or electric wave in order to receive the supplementary non-visual information from the target objects to photograph.

### DISCLOSURE OF INVENTION

### Technical Problem

One object of the present invention is to provide a digital photo content processing system for composing digital photo contents using images captured from a digital camera, automatically classifying the digital photo contents by persons in the captured images and automatically transmitting the classified digital photo contents to the persons, and a method and apparatus for transmitting/receiving digital photo contents in the digital photo contents system.

Another object of the present invention is to provide a digital photo content processing system for storing created images with supplementary information related to a digital photo content as well as basic information related to photographing conditions at the moment of creating the images, and instantly transmitting the composed digital photo contents or automatically transmitting it later.

### Technical Solution

In order to achieve the above objects, the present invention provides a method for transmitting digital photo contents in a digital photo content processing system including the steps of: a) photographing target persons in a photographing area and creating an image thereof; b) requesting supplementary information to identify each of the target persons to at least one target person in the photographing area and receiving at least one of personal IDs of the target persons; c) composing digital photo contents using the created image and the received personal IDs, and storing the composed digital photo contents; and d) classifying the stored digital photo contents by each of the target persons and transmitting the classified digital photo contents.

The method may further include the step of e) receiving location information of the photographing area.

According to an aspect of the present invention, there is provided a method of receiving digital photo contents in a digital photo content processing system including the steps of: a) transmitting an own personal ID when a request of transmitting supplementary information to identify a target person is received from a content transmitting unit of a photographer; b) receiving a digital photo content that is composed using an image captured at the content transmitting unit of the photographer and the personal ID; and c) displaying the received digital photo content.

According to another aspect of the present invention, there is provided an apparatus for transmitting digital photo contents including: a photographing unit for photographing target objects in a photographing area and creating an image thereof; a personal ID inquiring unit for requesting supplementary information to at least one of target persons in the photographing area; a personal ID receiving unit for receiving personal IDs from at least one of target persons; an information processing unit for composing digital photo contents using the created image and the personal ID and storing the composed digital photo contents; a content managing software unit for classifying the stored digital photo content by the received personal ID; and a wired/wireless transmitting unit for transmitting the classified digital photo contents.

The apparatus may further include a location information receiving unit for receiving location information of a photographing area.

According to still another aspect of the present invention, there is provided an apparatus for receiving digital photo contents including: a personal ID transmitting unit for transmitting an own personal ID in response to a request for supplementary information to identify a target person from a content transmitting unit of a photographer; a wired/wireless receiving unit for receiving digital photo contents composed using an image captured from the content transmitting unit and the personal ID; and a content viewer for displaying the received digital photo contents.

According to further still another aspect of the present invention, there is provided a system for processing digital photo contents including: a content transmitting unit for creating an image by photographing target objects in a photographing area, requesting supplementary information to at least one of target persons in the photographing area, receiving personal IDs from at least one of target persons, composing digital photo contents using the created image and the personal ID and storing the composed digital photo contents, and transmitting after classifying the stored digital photo content by the received personal ID; and a content receiving unit for transmitting an own personal ID when a request for supplementary information to identify a target person from a content transmitting unit of a photographer, receiving digital photo contents composed using an image captured from the content transmitting unit and the personal ID, and displaying the received digital photo contents.

### ADVANTAGEOUS EFFECTS

According to the present invention, the digital photo processing system according to the present invention automatically classifies, manages and transmits the digital photo contents by adding supplementary information into the digital photo contents when the digital photo contents are composed. Therefore, the digital photo processing system according to the present invention dissolves the inconveniences of users caused by manually processing the digital photo contents.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating a system for processing digital photo contents according to the related art;

FIG. 2 is a block diagram illustrating a digital photo content processing system according to an embodiment of the present invention;

FIG. 3 is a block diagram illustrating a content managing software unit shown in FIG. 2;

FIG. 4 is a view describing a method of matching a photographing area defined by a photographing unit and a request transmitting area for requesting a personal ID from a personal ID inquiring unit according to an embodiment of the present invention;

FIG. 5 is a flowchart illustrating an operation for automatically classifying digital contents and transmitting the classified digital content at the content transmitting unit in a digital photo content processing system according to an embodiment of the present invention; and

FIG. 6 is a flowchart showing an operation for transmitting a personal ID and receiving digital photo contents at a content receiving unit according to an embodiment of the present invention.

### BEST MODE FOR CARRYING OUT THE INVENTION

The present invention will be described by applying a digital photo content processing system that captures an image and transmits the contents of a recorded and photographed image to a receiving side to display the contents. In an embodiment of the present invention, users in a predetermined community for automatically adding information in a digital photo content and transmitting the digital photo content have personal information terminals, and they are connected through an ad-hoc network.

Also, the present invention is not a system formed of computing equipment capable of using a typical network infra and camera equipment as an independent apparatus for photographing. The present invention is a system similar to a personal portable computing terminal including functions for photographing objects, obtaining supplementary information, and storing the obtained supplementary information.

Hereinafter, preferred embodiments of the present invention will be described in detail with reference to the attached drawings.

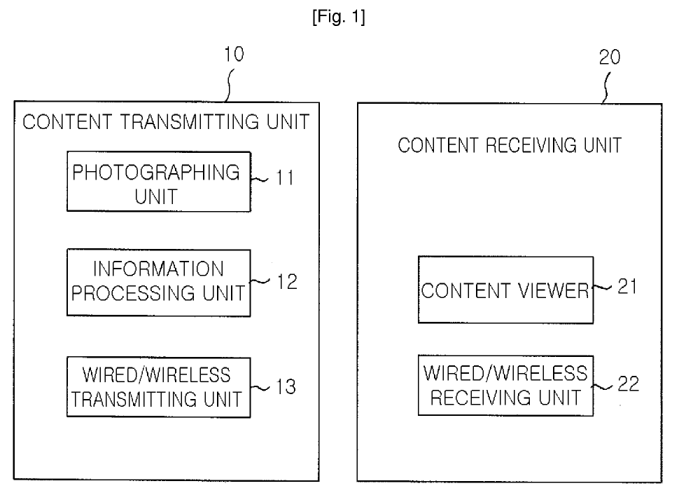

FIG. 1 is a block diagram illustrating a system for processing digital photo contents according to the related art.

Referring to FIG. 1, the typical digital photo contents processing system includes a content transmitting unit 10 and a content receiving unit 20. The content transmitting unit 10 includes a photographing unit 11 for photographing an object and creating an image thereof, an information processing unit 12 for recording photographing conditions, a time, and the like when the image is created, a wired/wireless transmitting unit 13 for passively and regularly transmitting contents related to the created image through a medium having a predetermined directivity. The content receiving unit 20 includes a content viewer 21 for receiving the contents and displaying the received contents, and a wired/wireless receiving unit 22 for receiving contents through the wired/wireless transmitting unit 13.

In the typical digital photo contents processing system according to the related art, the content transmitting unit 10 transmits the related contents regularly through a medium having a directivity although the content receiving unit 20 does not transmit any request. The content receiving unit 20 simply receives and gathers the transmitted contents together without transmitting any requests to the content transmitting unit 10 to transmit the related contents. The typical digital photo processing system generally searches and classifies contents using information related to photographing conditions.

A digital photo processing system according to the present embodiment creates supplementary information related to digital photo contents, such as, a personal ID for identifying persons in the created image, and the location information of a place where an image is captured, and the like, stores the created supplementary information with the captured image, and transmits them automatically. Dislike the conventional digital photo processing system, a content transmitting unit such as an object transmits related information in response to a request transmitted from a content receiving unit such as a camera. Herein, among the supplementary information, information about persons in the image is a persons ID which is very small data, and other information separately is stored in a database.

In the digital photo content processing system according to the present invention, the persons in the capture image transmits the supplementary information through an ad-hoc network. That is, a content receiving unit receives the requested contents through a non-directional wireless medium such as Bluetooth or wireless LAN in order to prevent the requested contents from being lost due to obstacles located between the content transmitting and the content receiving unit.

Hereinafter, the digital photo content processing system according to the present embodiment will be described with reference to accompanying drawings.

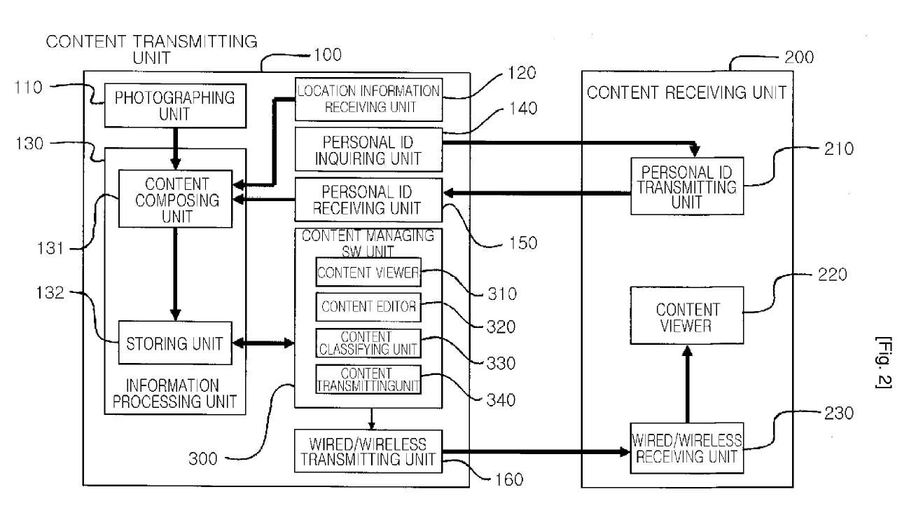

FIG. 2 is a block diagram illustrating a digital photo content processing system according to an embodiment of the present invention.

Referring to FIG. 2, the digital photo content processing system according to the present embodiment is divided into a content transmitting unit 100, and a content receiving unit 200. The content transmitting unit 100 and the content receiving unit 200 are distinguished from each other according to its detailed function, operations to perform and the direction of flowing contents. However, they may coexist in a single system. In the present embodiment, content receiving units 200 in terminals belonging to persons in an image captured by the content transmitting unit 100 are described as the example of the content receiving unit 200. Therefore, the digital photo content processing system according to the present embodiment may be configured to have a plurality of content receiving units 200 which are interacted with single content transmitting unit 100.

The content transmitting unit 100 includes a photographing unit 110, a location information receiving unit 120, a personal ID requesting unit 130, a personal ID receiving unit 140, an information processing unit 150, a wired/wireless transmitting unit 160, and a content managing software unit 300. The content receiving unit 200 includes a personal ID transmitting unit 210, a wired/wireless receiving unit 220, and a content viewer 230.

The photographing unit 110 photographs a target object and creates the image thereof. For example, the photographing unit 110 may be a digital camera. Then, the photographing unit 110 transmits the captured image to the information processing unit 150.

The location information receiving unit 120 receives location information about a place where target objects are photographed and transmits the received location information to the information processing unit 150. For example, a global positioning system (GPS) may be used to identify the location information.

The personal ID inquiring unit 130 requests the personal ID transmitting units 210 belonged to target persons in a photographing area to transmit personal IDs using an infrared ray and a directional electric wave, where the photographing area is defined by the photographing unit 110. That is, the personal ID inquiring unit 130 detects all objects in the photographing area by radiating the infrared ray or the directional electric wave to the photographing area and requests the detected objects to transmit personal ID values.

The personal ID receiving unit 140 receives a personal ID transmitted from the personal ID transmitting unit 210 as a response of the request from the personal ID inquiring unit 130, and transmits the received personal ID to the information processing unit 150.

The information processing unit 130 includes a content composing unit 151 for composing an image content by gathering the created image from the photographing unit 110, the personal ID values from the personal ID receiving unit 140, and the location information obtained from the location information receiving unit 120, and a storing unit 152 for storing the composed image content.

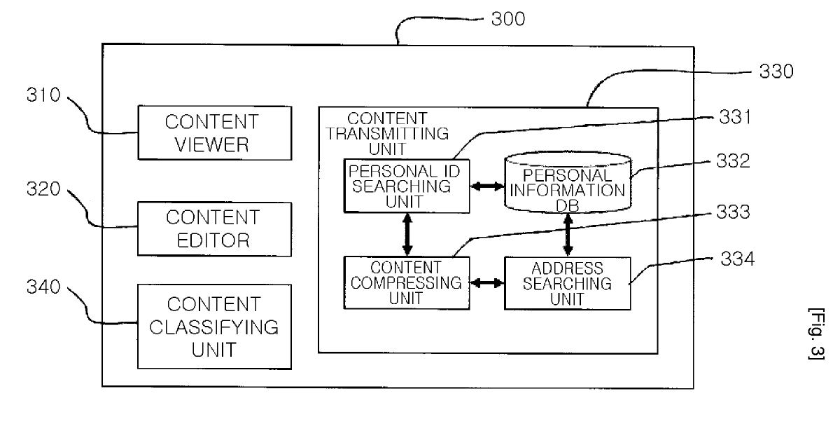

The content managing software unit 300 checks, edits, classifies and transmits the composed image contents in the place where the images are captured. Referring to FIG. 3, the internal structure of the content managing software unit 300 will be described in more detail. The content managing software unit 300 includes a content viewer 310, a content editor 320, a content classifying unit 330, and a content transmitting unit 340.

The content viewer 310 functions as an image viewer for instantly checking the digital photo content composed and stored by the information processing unit 150. The content editor 320 edits the digital photo content displayed through the content viewer 310.

The content classifying unit 330 includes a personal ID searching unit 331, a personal information database 332, a content compressing unit 333, and an address searching unit 334. The content classifying unit 330 classifies and organizes digital photo contents by data stored into the digital photo contents with the captured images at the information processing unit 150. The personal ID searching unit 331 searches a personal ID included in a digital photo contents from the personal information database 332 having the data of the persons in the captured images, and transmits the address of the searched personal ID to the address searching unit 334. The content compressing unit 333 selectively performs compression. An image may be transmitted to a target person to photograph instantly after photographing the target person without compressing the image. On the contrary, when the images are transmitted after gathering the images for a predetermined time, images are compressed and transmitted. If a plurality of digital photo contents are transmitted, the content compressing unit 333 is driven by automatically classifying the digital photo contents according to the personal ID or the destination address.

The content transmitting unit 340 transmits the digital photo contents from an object for receiving the digital photo contents as data classified at the content classifying unit 330 to the content receiving unit 200 using the wired/wireless transmitting unit 160, instantly or later.

The wired/wireless transmitting unit 160 establishes an ad-hoc network between members in a community, that is, the wired/wireless receiving units 220 of the content receiving unit 200 in order to transmit the related information through non-directional medium. That is, wired/wireless transmitting unit 160 takes a charge of transmitting digital photo contents through a wired/wireless network. Herein, Bluetooth may be used to configure the ad-hoc network.

The personal ID transmitting unit 210 transmits the own personal ID to the personal ID receiving unit 140 through the ad-hoc network when the personal ID transmitting unit 210 receives the request of the personal ID transmitted from the personal ID inquiring unit 130 through the directional light or electric wave.

The wired/wireless receiving unit 220 configures an ad-hoc network with members in the community, and receives digital photo contents composed and classified at the wired/wireless transmitting unit 160 of the content transmitting unit 100 through the wired/wireless network.

The content viewer 230 displays the digital photo contents received through the wired/wireless receiving unit 220 in order to allow a user to visually check the received image.

Hereinafter, an operation for matching a photographing area defined by the photographing unit 110 and a request transmitting area for requesting a personal ID between the personal ID inquiring unit 130 and the personal ID receiving unit 140 in the content transmitting unit 100 will be described with reference to an accompanying drawing.

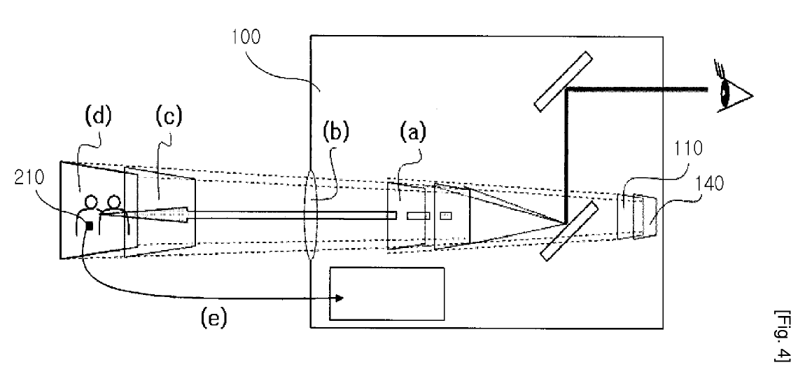

FIG. 4 is a view describing a method of matching a photographing area defined by a photographing unit and a request transmitting area for requesting a personal ID from a personal ID inquiring unit according to an embodiment of the present invention.

Referring to FIG. 4, the personal ID inquiring unit 130 radiates lights or electric wave, for example, an infrared ray, in a direction to a photographing area where images are formed at the photographing unit 110 of the content transmitting unit 100. Therefore, the IDs of members in the photographing area can be obtained excepting members are not in the photographing area of the photographing unit 110 although the members are included in the community and the ad-hoc network.

In FIG. 4, the reference (a) denotes a real photographing area defined by the photographing unit 110, and it assumes that the electric wave or the directive light may have the identical reflective index of a visible ray against a lens (b). The reference (c) denotes a personal ID requesting area matched with the photographing target (d) with the identical reflective index.

As described above, the personal ID transmitting unit 210 of the content receiving unit 200 belonging to the member of a community who receives the request of the personal ID transmits the own ID as the response (e) to the personal ID receiving unit 140 of the content transmitting unit 100 belonging to the photographer.

Hereinafter, a method of automatically adding information based on digital photo contents and transmitting the added information in a digital photo content processing system according to the present invention will be described with reference to accompanying drawings. At first, an operation for automatically classifying and transmitting the digital photo contents at the content transmitting unit will be described.

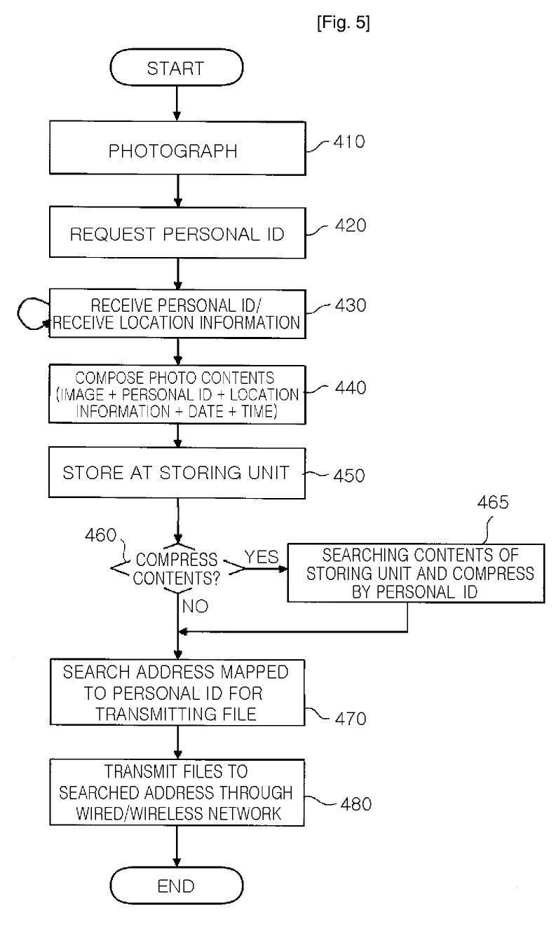

FIG. 5 is a flowchart illustrating an operation for automatically classifying digital contents and transmitting the classified digital content at the content transmitting unit in a digital photo content processing system according to an embodiment of the present invention.

Referring to FIGS. 1 through 5, the content transmitting unit 100 photographs a target object in a photographing area through the photographing unit 110 and composes the digital image thereof at step S410.

At step S420, the content transmitting unit 100 requests target objects in the photographing area to transmit personal IDs using an infrared ray or a directive electric wave. At step S430, the personal IDs are received from the personal ID transmitting units 210 of target objects through an ad-hoc network. Herein, the location information receiving unit 120 of the content transmitting unit 100 receives the location information of the photographing area.

At step S330, the content transmitting unit 100 composes digital photo contents of target objects by combining the captured image from the information processing unit 150, the received personal IDs, the location information, the photographing date and time. At step S450, the storing unit 152 stores the composed digital photo contents.

At step S460, the content managing software unit 300 of the content transmitting unit 100 automatically classifies the digital photo contents stored in the storing unit 150 based on data in the digital photo contents such as the personal IDs or the destination address.

At step S470, the content transmitting unit 100 determines whether the digital photo contents will be compressed or not. In case of compressing the digital photo contents, the content transmitting unit 100 searches the digital photo contents stored in the content transmitting unit 100 and compresses the searched digital photo contents according to the personal IDs at step S475.

At step S480, the content transmitting unit 100 searches an address mapped to a personal ID in order to transmit files of the digital photo contents or compressed files when the compression is not required or after compressing the digital photo contents. In the step S480 the wired/wireless transmitting unit 160 transmits the files or the compressed files to the content receiving unit 200 of the searched address through a wired/wireless network such as an ad-hoc network. That is, the files or the compressed files are transmitted to the content receiving unit 200 through a non-directional medium such as Bluetooth or wireless LAN in order to prevent the transmitting files from being lost while transmitting.

Hereinafter, an operation for transmitting a personal ID and receiving digital photo contents at a content receiving unit will be described with reference to accompanying drawings.

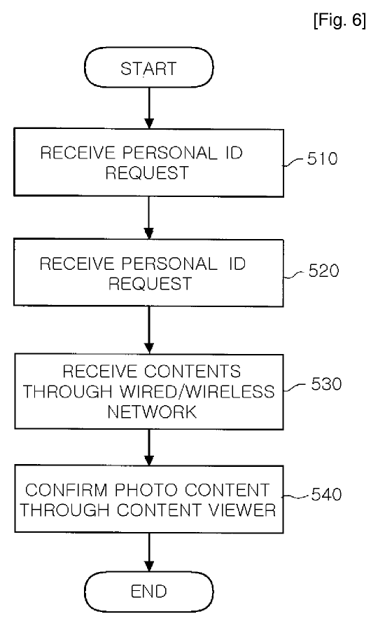

FIG. 6 is a flowchart showing an operation for transmitting a personal ID and receiving digital photo contents at a content receiving unit according to an embodiment of the present invention.

Referring to FIGS. 1 through 6, the content receiving unit 200 receives the request of the personal ID from the personal ID inquiring unit 103 of the content transmitting unit 100 at step S510. At step S520, the content receiving unit 200 transmits the own personal ID to the content transmitting unit 100. At step S530, the wired/wireless receiving unit 220 of the content receiving unit 200 receives digital photo contents through a wired/wireless network. At step S540, the content viewer 230 displays the received digital photo contents.

As described above, the digital photo processing system according to the present invention automatically classifies, manages and transmits the digital photo contents by adding supplementary information into the digital photo contents when the digital photo contents are composed. Therefore, the digital photo processing system according to the present invention dissolves the inconveniences of users caused by manually processing the digital photo contents.

Also, the digital photo processing system according to the present invention provides a faster object recognition speed by recognizing objects through searching a database using a personal ID instead of using the image recognition technology. Furthermore, the digital photo processing system according to the present invention uses an active scheme of requesting target objects to transmit personal information instead of using a passive scheme of simply receiving information that is regularly transmitted from the target objects. Moreover, the related information is transmitted through a non-directional medium, an ad-hoc network formed of wireless LAN or Bluetooth, in order to prevent the transmitting files from being lost while transmitting.

Generally, the personal information terminal includes addresses of each community member. Therefore, the digital photo processing system according to the present invention does not require related information excepting a personal ID to transmit in order to transfer and obtain necessary information. Since the received personal ID and the related supplementary information can be obtained from a database belonging to each individual, it can reduce chances of disturbing a personal privacy and chances of losing information during transmission in a wireless region.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A method for transmitting digital photo contents in a digital photo content processing system comprising the steps of:
a) photographing target persons in a photographing area and creating an image thereof;
b) requesting supplementary information to identify each of the target persons to at least one target person in the photographing area and receiving at least one of personal IDs of the target persons;
c) composing digital photo contents using the created image and the received personal IDs, and storing the composed digital photo contents; and
d) classifying the stored digital photo contents by each of the target persons and transmitting the classified digital photo contents.

2. The method of claim 1, further comprising the step of e) receiving location information of the photographing area.

3. The method of claim 2, wherein the digital photo contents are composed by combining the created image, the received personal IDs, the location information of the photographing area and pre-stored photographing conditions.

4. The method of claim 1, further comprising the step of f) building a database of supplementary information related to the received personal ID in advance.

5. The method of anyone of claims 1 to 4, further comprising the step of searching the stored digital photo contents and compressing the searched digital photo contents according to the personal ID.

6. The method of claim 1, wherein in the step b), the supplementary information is requested by radiating a directional light or an electric wave to at least one of content receiving units of target persons.

7. The method of anyone of claims 1 to 6, wherein the personal ID is received from the content receiving unit through an ad-hoc network.

8. The method of claim 1, wherein the step d) includes the steps of:
d-1) classifying the stored digital photo contents by the received personal ID using data stored with the created image;
d-2) searching an address mapped to a personal ID of a target person to transmit the classified digital photo content; and
d-3) transmitting the classified digital photo content to a content receiving unit of the searched address.

9. The method of anyone of claims 1 to 8, wherein the digital photo contents are transmitted according to the personal IDs through an ad-hoc network.

10. A method of receiving digital photo contents in a digital photo content processing system comprising the steps of:
a) transmitting an own personal ID when a request of transmitting supplementary information to identify a target person is received from a content transmitting unit of a photographer;
b) receiving a digital photo content that is composed using an image captured at the content transmitting unit of the photographer and the personal ID; and
c) displaying the received digital photo content.

11. The method of claim 10, wherein the digital photo content is composed by combining the captured image, the personal ID, the location information of the photographing area and photographing conditions.

12. The method of claim 10, wherein in the step a), the request is received through a directional light or an electric wave radiated from the content transmitting unit of the photographer.

13. The method of claim 10, wherein the personal ID is transmitted through an ad-hoc network as a response of the request.

14. The method of claim 10, wherein in the step b), the digital photo content which is transmitted according to personal IDs through an ad-hoc network is received.

15. An apparatus for transmitting digital photo contents, comprising:
a photographing unit for photographing target objects in a photographing area and creating an image thereof;
a personal ID inquiring unit for requesting supplementary information to at least one of target persons in the photographing area;
a personal ID receiving unit for receiving personal IDs from at least one of target persons;
an information processing unit for composing digital photo contents using the created image and the personal ID and storing the composed digital photo contents;
a content managing software unit for classifying the stored digital photo content by the received personal ID; and
a wired/wireless transmitting unit for transmitting the classified digital photo contents.

16. The apparatus of claim 15, further comprising a location information receiving unit for receiving location information of a photographing area.

17. The apparatus of claim 16, wherein the digital photo content is composed by combining the created image, the received personal ID, the location information of the photographing area and predetermined photographing conditions.

18. The apparatus of claim 15, wherein the information processing unit includes:
a content composing unit for composing the digital photo content using the created image and the personal ID; and
a storing unit for storing the composed digital photo content.

19. The apparatus of claim 15, wherein the content managing software includes:
a content viewer for displaying the composed digital photo content;
a content editor for editing the displayed digital photo content;
a content classifying unit for classifying the stored digital photo contents by the personal ID using data stored with the created image; and
a content transmitting unit for transmitting the classified digital photo content to the wired/wireless transmitting unit.

20. The apparatus of claim 19, wherein the content classifying unit includes:
a database for storing detailed supplementary information about the target persons to photograph;
a personal ID searching unit for searching a personal ID of a target person to transmit the digital photo content from the database; and
an address searching unit for searching an address mapped to a personal ID of a target person to transmit the classified digital photo content.

21. The apparatus of claim 20, wherein the content classifying unit further includes a content compressing unit for compressing the classified digital photo content.

22. An apparatus for receiving digital photo contents comprising:
a personal ID transmitting unit for transmitting an own personal ID in response to a request for supplementary information to identify a target person from a content transmitting unit of a photographer;
a wired/wireless receiving unit for receiving digital photo contents composed using an image captured from the content transmitting unit and the personal ID; and
a content viewer for displaying the received digital photo contents.

23. The apparatus of claim 22, wherein the wired/wireless receiving unit receives the digital photo content transmitted according to personal IDs through an ad-hoc network.

24. The apparatus of claim 23, wherein the persona ID transmitting unit receives the supplementary information for classifying individuals through a directional light or an electric wave from the content transmitting unit of the photographer and transmits the own personal ID through an ad-hoc network.

25. The apparatus of claim 22, wherein the digital photo content is composed by combining the captured image, the personal ID, location information of a photographing area and pre-stored photographing conditions.

26. A system for processing digital photo contents comprising:
a content transmitting unit for creating an image by photographing target objects in a photographing area, requesting supplementary information to at least one of target persons in the photographing area, receiving personal IDs from at least one of target persons, composing digital photo contents using the created image and the personal ID and storing the composed digital photo contents, and transmitting after classifying the stored digital photo content by the received personal ID; and
a content receiving unit for transmitting an own personal ID in response to a request for supplementary information to identify a target person from a content transmitting unit of a photographer, receiving digital photo contents composed using an image captured from the content transmitting unit and the personal ID, and displaying the received digital photo contents.

27. The system of claim 26, wherein the content transmitting unit receives location information of a photographing area, previously builds a database for detailed supplementary information related to the received personal ID and stores the database, and searches the stored digital photo contents and compresses the searched digital photo contents.

28. The system of claim 26, wherein the content receiving unit receives the digital photo content transmitted according to a personal ID through an ad-hoc network.

29. The system of claim 26, wherein the content receiving unit receives a request for supplementary information for identifying individuals through a directive light and electric wave from the content transmitting unit of the photographer and transmitting the own personal ID through an ad-hoc network.

30. The system of anyone of claims 26 and 27, wherein the digital photo content is composed by combining the created image, the personal ID, location information of a photographing area and pre-stored photographing conditions.
